(19) United States
(12) Patent Application Publication
(10) Pub. No.: US 2009/0314018 A1
(43) Pub. Date: Dec. 24, 2009

(54) COMPRESSOR POWER CONTROL

(75) Inventors: Jeffrey J. Burchill, Syracuse, NY (US); Yu H. Chen, Manlius, NY (US); Harold P. Hill, JR., Jamesville, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: Carrier Corporation, Farmington, CT (US)

(21) Appl. No.: 12/303,208

(22) PCT Filed: Jun. 15, 2006
(86) PCT No.: PCT/US06/23303

§ 371 Date: Dec. 2, 2008

(51) Int. Cl. F25B 49/02; F25B 1/00; F01C 1/02; F25D 23/12; B60H 1/32

(52) U.S. Cl. 62/228.4; 62/498; 418/55.1; 62/239; 62/115

(57) ABSTRACT

Cooling is provided to the power electronics of a compressor speed control system by way of refrigerant that is routed from a refrigeration system, through the power electronics, and then back to the refrigeration system. The amount of refrigerant flowing to the power electronics is automatically regulated to that needed to cool the electronics since both are substantially proportional to compressor speed. The housing for the power electronics is mounted directly to the side of the compressor, and the compressor is resiliently mounted to a support to thereby provide shock protection to the power electronics.

### BACKGROUND OF THE INVENTION

This invention relates generally to refrigeration systems and, more particularly, to transport refrigeration systems with compressor speed controls.

For the transport of goods that are required to be kept cold or frozen, vehicles such as trucks or trailers or refrigerated containers are provided with a refrigeration system which interfaces with the cargo space to cool the cargo down to a predetermined temperature. The refrigeration system includes a compressor which is driven by an electric motor, with the most common type being a hermetic compressor with the motor being disposed within the compressor housing.

In the usual transport refrigeration system, the duty cycle of the compressor will vary substantially depending on various factors such as the ambient temperature, the type and volume of cargo, the desired temperature for the cargo space, and the frequency and length of time that the cargo space is opened for loading or unloading. The compressor must be designed to operate at sufficient capacity and speed to provide a cooling capability that is necessary to satisfy the most adverse conditions (such as pulldown) that are anticipated. However, during a majority of the operating time, the compressor can be operating at less than full capacity and at times may be completely shut off. For purposes of efficiency, it is therefore become common to provide a control system for varying the speed of the compressor so as to thereby maximize the efficiency while at the same time meeting the demands of the cooling system.

One way in which the speed control is accomplished is by way of a power electronics unit which is used to selectively vary the power to the drive motor, and in particular, by varying the current, voltage and/or frequency thereto. When using such a unit with its various electronic components, it has been recognized that even the most robust power electronic systems are subject to malfunction and/or failure unless they are protected from certain unfavorable conditions. Firstly, it is recognized that the inverter must be protected against overheating. This is often accomplished by the use of heat sinks and by providing fans to circulate air through the electronic components to provide the necessary cooling thereof. In this regard, it is recognized that, generally, the size of the power electronics package can be reduced as the cooling capabilities are increased.

The second condition against which one would preferably protect a power electronics unit is that of mechanical shock that can be transferred to the electronic components by jarring movements of the type that may occur in moving vehicles. This can be accomplished by providing resilient structure between the inverter apparatus and the structure to which it is mounted.

### SUMMARY OF THE INVENTION

Briefly, in accordance with one aspect of the invention, the power electronics package is cooled by way of refrigerant that is being returned to the suction inlet of the compressor, with the suction gas being routed to flow first through the power electronics package and then to the suction port of the compressor. In this way, the electronic components are more effectively cooled than by the mere circulation of air therethrough, and thereby allowing for the use of a smaller power electronics package.

In accordance with another aspect of the invention, the speed of the compressor, as controlled by the electronics package, is generally proportional to both the degree of heat generated by the electronic components and the amount of refrigerant that is circulated by the compressor, thereby providing an inherent balanced arrangement to obtain efficient operation with a smaller electronics package.

In accordance with yet another aspect of the invention, a power electronics unit is mounted directly to the side of a hermetic compressor, with the compressor itself being mounted on shock mounts. In this way, the power electronics unit derives the benefit of the compressor mounting system without the need for its own resilient mounting system.

In the drawings as hereinafter described, a preferred embodiment is depicted; however, various other modifications and alternate constructions can be made thereto without departing from the spirit and scope of the invention.

### BRIEF DESCRIPTION OF THE DRAWINGS

FIG. 1 is a schematic illustration of a transport refrigeration system in accordance with one embodiment of the present invention.

FIG. 2 is a schematic illustration of a power electronics unit as mounted to a compressor in accordance with one embodiment of the present invention.

FIG. 3 is a schematic illustration of a power electronics cooling arrangement in accordance with one aspect of the invention.

FIG. 4 is a schematic illustration thereof in accordance with an alternative embodiment thereof.

FIG. 5 is a graphic illustration of a power dissipation de-rating curve in accordance with one aspect of the invention.

### DESCRIPTION OF THE PREFERRED EMBODIMENT

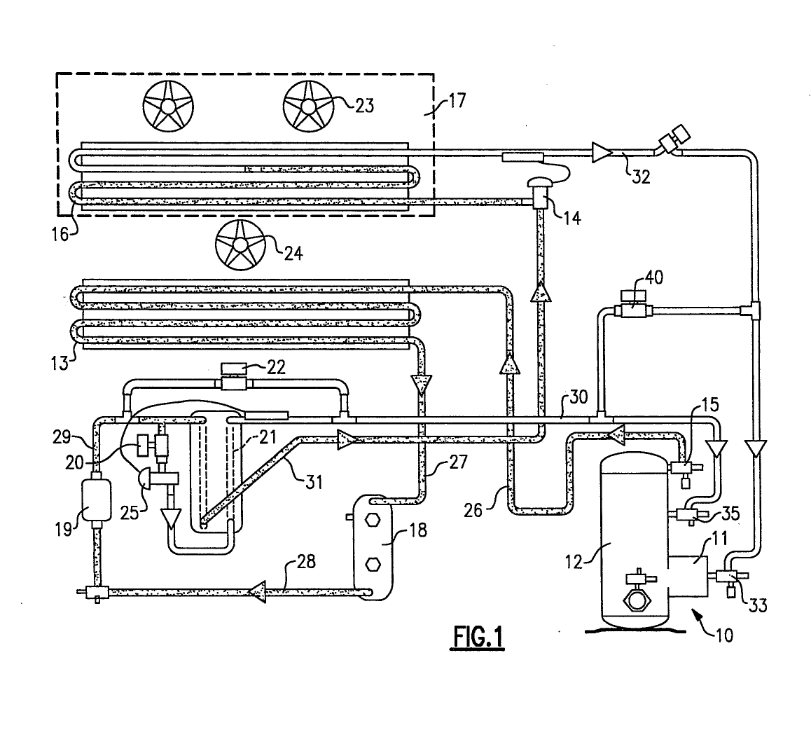

Referring to FIG. 1, the invention is shown generally at 10 wherein a power electronics package 11 is supportably attached to a compressor 12, with the details thereof to be described more fully hereinafter.

The compressor 12 is a hermetic compressor with the motor enclosed in its casing and may be a reciprocating compressor, a rotary compressor or a scroll compressor. It is operatively connected within a refrigeration system that includes, in serial flow relationship, a condenser coil 13, an expansion device 14, and an evaporator coil 16. It preferably also includes a receiver 18, a filter/dryer 19, an economizer heat exchanger 21 and a liquid injection valve 22.

The evaporator coil 16 is so positioned within the cargo space 17 as to provide cooling thereto, and one or more fans 23 are provided to circulate the air from the cargo space over the evaporator coil 16. Similarly, the condenser coil 13 is so positioned that its fan 24 is operable to circulate ambient air thereover for purposes of condensing the refrigerant gases within the condenser coil 13.

In operation, the refrigerant gas passes from discharge service connection 15 of the compressor 12 along line 26 to the condenser coil 13 with the condensed refrigerant then passing along line 27 to the receiver 18 where liquid refrigerant can be temporarily stored. The liquid refrigerant then passes along line 28 to the filter dryer 19 which acts to remove any impurities from the refrigerant. The refrigerant then passes along line 29 to the economizer heat exchanger 21 and from there along line 31 to the expansion device 14. The expanded refrigerant passes to the evaporator 16 for purposes of cooling the cargo space, and then along line 32 to a suction service connection 33 through the power electronics package 11 and to the compressor 12.

In an economized mode of operation, the frozen range and pull down capacity of the unit is increased by subcooling the liquid refrigerant entering the evaporator expansion valve such that overall efficiency is increased because the gas leaving the economizer enters the compressor at a higher pressure, therefore requiring less energy to compress it to the required condensing conditions.

Liquid refrigerant for use in economizer circuit is taken from the main liquid line as it leave the filter dryer 19 with the flow being activated when the controller energizes the economizer celluloid valve 20. A liquid refrigerant flows through the economizer expansion valve 25 the economizer heat exchanger 21 and the line 30 to the economizer service connection 35.

During unloaded operation, the economizer solenoid valve 20 is closed and the unloading solenoid valve 40 is opened such that a portion of the mid-staged compressed gas is bypassed to decrease compressor capacity.

It should be understood that the power electronics package 11 can be any electronic system that is provided for the purpose of varying the speed of the compressor 12, and the compressor can be of any type of rotary or reciprocating compressor that is driven by an ac or a dc motor. For example, it can be an ac induction motor with an inverter to vary its speed. Alternatively, the speed control can be provided by other apparatus such as a PWM (pulse width modulation) unit or even a variable resistance power electronics package.

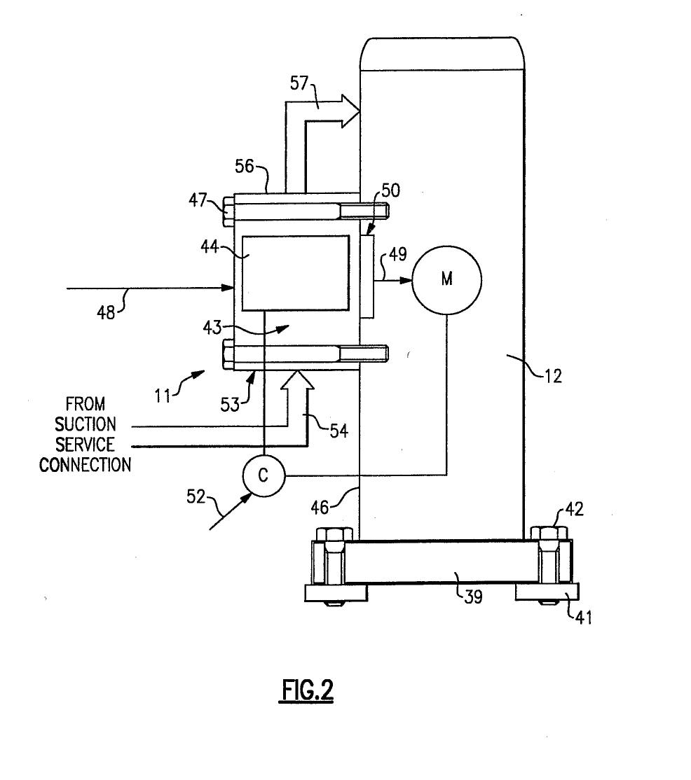

Referring now to FIG. 2, the compressor 12 and the mounted power electronics package 11 is shown in greater detail. The compressor drive motor M is, of course, operably disposed within the compressor 12, which is mounted in a vertical position by way of a base 39 being attached to a pair of resilient shock mounts 41 by bolts 42. In this way, the compressor 12 is protected against any shock that may otherwise be transferred thereto by way of jarring motions or sudden movements of the vehicle, for example. That is, the shock is absorbed by the shock mounts 41 with the compressor 12 being relatively isolated from such shocks.

The power electronics package 11 includes a power wiring terminal block housing 43 which contains the power electronics 44. As will be seen, the power wiring terminal block housing 43 is rigidly secured to a side 46 of the compressor 12 by a plurality of bolts 47. The resilient mounting that is normally required for the power electronics package 11 is not required since, because of the direct connection to the compressor 12, the power electronics package 11 derives the benefit of the shock mounts 41 for the compressor. Thus, the power electronics package 11 is protected from shocks by way of the shock mounts 41.

An electrical power input is made to the power electronics 44 by way of electrical line 48, and the power electronics 44 is electrically connected to the motor M by way of electrical line 49, preferably by way of a fusite member 50.

A control device C is electrically interconnected between the power electronics 44 and the motor M so as to selectively vary the power from the power electronics 44 to control the speed of the motor M in a desired manner, with certain operational parameters and sensed conditions being provided to the control C by way of various inputs indicated at numeral 52.

Even more important than the resilient mounting benefit is that of using the refrigerant system to cool the electrical components within the inverter power electronics 44 by way of circulating the returning refrigerant gas therethrough. That is, at one side 53 of the housing 43, provision is made to introduce the flow of suction gas as shown at 54 in such a way as to cause it to flow through the housing 43 and, in doing so to cool the power electronics 44. The refrigerant gas then flows out the other side 56, with the flow stream 57 then passing to the suction inlet of the compressor 12. In this way, the electronic components can be more efficiently cooled than by way of the usual method of circulating air thereover, and will thus allow for the reduction in size and weight of the power electronic package 11. Further, it will allow operation of the system in a more harsh environment such as at higher ambient temperatures and higher shock loads.

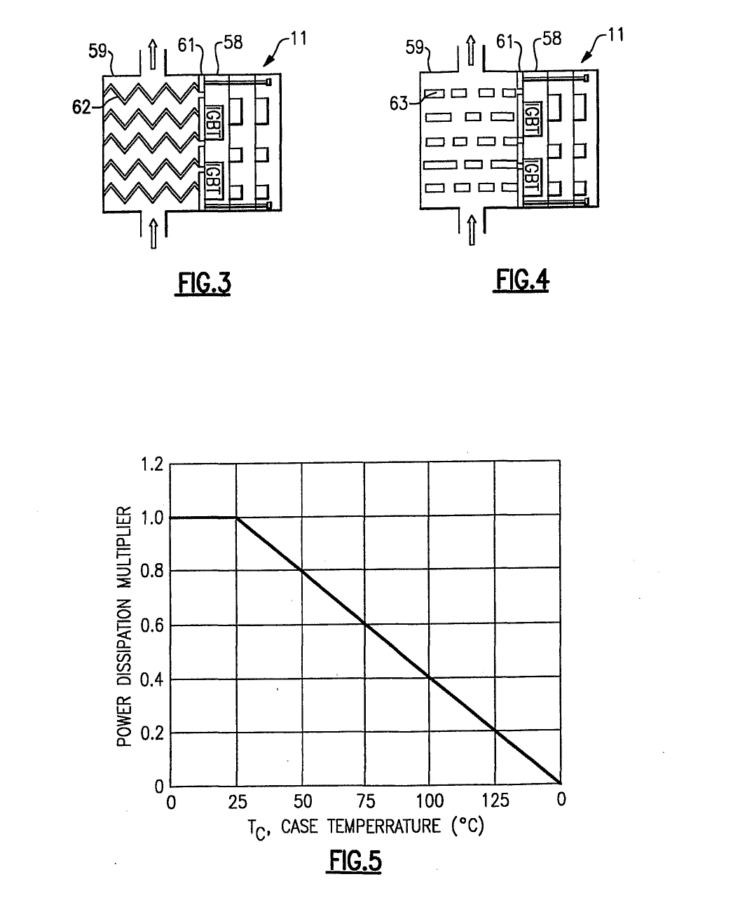

Considering now in greater detail as to how the refrigerant is applied to cool the electronic components, reference is made to FIGS. 3 and 4 where two alternatives are shown. In each case, the power electronics package 11 is divided into sections, a power electronics section 58 and a refrigeration section 59, with the two sections being divided by an intermediate wall or heat sink 61. Within the power electronics section 58 are located the power electronics and the power switching semiconductors such as, for example, insulated gate bipolar transistors (IGBTs). The power switching semiconductors that require cooling are mounted to the heat sink 61 as shown. The heat sink consists of a highly thermally conductive metal material.

In the refrigeration section 59, there are a plurality of heat transfer elements that are integrally connected to the heat sink 61 and whose geometry are designed to maximize the heat transfer effect from the heat sink 61 to the low temperature refrigerant that flows through this section. In FIG. 3, for example, the heat transfer elements comprise a plurality of wavy fins 62, wherein in FIG. 4, the heat transfer elements comprise a plurality of staggered perforated plates 63. In operation, the low temperature refrigerant flows into the inlet 64, across the heat transfer elements 62 or 63 and out of the outlet 66 where it passes to the suction of the compressor. The cooling effect of the low temperature refrigerant will keep the power switching semiconductors below a specified power semiconductor case temperature. Maximizing the power semiconductor case temperature will allow less power dissipation de-rating of the power semiconductor and thereby allow a smaller power semiconductor package for the same amount of power dissipation. The effect of the cooling will therefore minimize the size of the power switching semiconductor.

Referring to FIG. 5, the power semiconductor power dissipation de-rating curve is shown for a typical power switching power semiconductor to indicate that as the case temperature is decreased, the power dissipation multiplier is proportionally increased.

It should be recognized that since the power switching semiconductors are part of the compressor speed control there is an inherent relationship between the amount of cooling that is required and the amount of cooling that is provided. That is, when the compressor is operating at full speed the power switching semiconductors will be operating at maximum capacity and maximum generation of heat. At the same time however, since the compressor is operating at full speed the amount of refrigerant being circulated through the system is at a maximum flow rate, and therefore the maximum cooling effect is provided to the heat sink 61. On the other hand, when the compressor is operating at lower speeds, the heat loss from the power switching semiconductors will be lower as will be the rate of refrigerant flow through the system. In this way, the amount of cooling that occurs is automatically adjusted with changes in compressor motor speed.

We claim:

1. A power control apparatus for a refrigeration system having in serial flow relationship a compressor, a condenser, an expansion device and an evaporator, comprising:
an electric drive motor for driving the compressor, the drive motor being of the variable speed type;
an electrical power source; and
a power electronics package for receiving electrical power from said electrical power source and selectively providing electrical power to said drive motor in such a manner as to cause the compressor to be driven at desired speeds to optimize efficiency; and
refrigerant flow conduits for conducting the flow of refrigerant from the refrigerant system through said power electronics package for the cooling thereof; wherein said power electronics package is rigidly mounted to said compressor and including at least one resilient mount for resiliently mounting and supporting the compressor in its installed position.

2. A power control apparatus as set forth in claim 4 wherein the need for cooling of said electronics package is substantially proportional to the speed of the compressor.

3. A power control apparatus as set forth in claim 2 wherein the amount of refrigerant being passed through the electronics package is substantially proportional to the speed of the compressor.

4. A power control apparatus for a refrigeration system having in serial flow relationship a compressor, a condenser, an expansion device and an evaporator, comprising:
an electric drive motor for driving the compressor, the drive motor being of the variable speed type;
an electrical power source; and
a power electronics package for receiving electrical power from said electrical power source and selectively providing electrical power to said drive motor in such a manner as to cause the compressor to be driven at desired speeds to optimize efficiency; and
refrigerant flow conduits for conducting the flow of refrigerant from the refrigerant system through said power electronics package for the cooling thereof; wherein said refrigeration is refrigerant gas from the evaporator.

5. A power control apparatus as set forth in claim 4 wherein said power electronics comprises an inverter.

6. A power control apparatus as set forth in claim 4 wherein said power electronics package is mounted on one side of said compressor.

7. A power control apparatus as set forth in claim 4 wherein said compressor is a hermetic compressor.

8. A power control apparatus as set forth in claim 4 wherein said compressor is a scroll compressor.

9. A power control apparatus as set forth in claim 4 wherein said drive motor is an AC induction motor.

10. (canceled)

11. (canceled)

12. A method of controlling the speed of a drive motor adapted to drive a compressor within a refrigeration system having in serial flow relationship a compressor, a condenser, an expansion device and an evaporator, comprising the steps of:
providing an electric drive motor for driving the compressor, said drive motor being of the variable speed type;
providing an electrical power source;
providing a power electronics package for receiving electrical power from said electrical power source and selectively providing electrical power to said drive motor in such a manner as to cause the compressor to be driven at desired speeds to thereby optimize efficiency; and
conducting the flow of refrigerant from the refrigeration system to said power electronics system for the cooling thereof;
wherein said power electronics package is rigidly mounted to said compressor and including the further step of resiliently mounting said compressor in its installed position.

13. A method as set forth in claim 15 wherein the amount of refrigerant flow conducted to the power electronics system is substantially proportional to the speed of the compressor.

14. A method as set forth in claim 13 wherein the need for cooling of the power electronics system is substantially equal to the speed of the compressor.

15. A method of controlling the speed of a drive motor adapted to drive a compressor within a refrigeration system having in serial flow relationship a compressor, a condenser, an expansion device and an evaporator, comprising the steps of:
providing an electric drive motor for driving the compressor, said drive motor being of the variable speed type;
providing an electrical power source;
providing a power electronics package for receiving electrical power from said electrical power source and selectively providing electrical power to said drive motor in such a manner as to cause the compressor to be driven at desired speeds to thereby optimize efficiency; and
conducting the flow of refrigerant from the refrigeration system to said power electronics system for the cooling thereof wherein said refrigerant is refrigerant gas from the evaporator.

16. A power control apparatus as set forth in claim 15 wherein said power electronics comprises an inverter.

17. A method as set forth in claim 15 wherein said power electronics package is mounted to one side of said compressor.

18. A method as set forth in claim 15 wherein said compressor is a hermetic compressor.

19. A method as set forth in claim 15 wherein said compressor is a scroll compressor.

20. A method as set forth in claim 15 wherein said drive motor is an AC induction motor.

21. (canceled)

22. (canceled)

23. A method as set forth in claim 15 and including the step of conducting the flow of refrigerant gas through said power electronics package and then into said compressor.

24. A refrigeration system of the type having a motor driven compressor, a condenser, an expansion device and an evaporator connected in serial flow relationship and including a control apparatus for controlling the speed of the compressor drive motor, comprising:
an power electronics package comprising a housing with associated electronic components disposed therein and being electrically connected to said drive motor; and
cooling apparatus for said power electronics package, said cooling apparatus including flow conducting elements for conducting the flow of refrigerant from the refrigeration system and through said housing to cool said electronic components and then directly into a suction port of said compressor.

25. A refrigeration system as set forth in claim 24 and including a resilient mounting arrangement for supportably mounting the compressor and wherein said housing is supportably mounted to said compressor.

26. A refrigeration system as set forth in claim 25 wherein said compressor is a hermetic compressor that is mounted vertically and said housing is mounted on a side thereof.

27. A refrigeration system as set forth in claim 24 wherein said power electronic package comprises an inverter and said drive motor is an AC induction motor.

28. A refrigeration system as set forth in claim 25 wherein said housing is rigidly mounted to said compressor.
